(19) United States
(12) Patent Application Publication
(10) Pub. No.: US 2026/0176768 A1
(43) Pub. Date: Jun. 25, 2026

(54) METHOD FOR PREPARING IN-SITU SYNTHESIZED Al2O3 CERAMIC-REINFORCED HIGH-ENTROPY ALLOY (HEA) COATING DOPED WITH TRACE AMOUNT OF B THROUGH LASER CLADDING

(71) Applicant: Kunming University of Science and Technology, Kunming City (CN)

(72) Inventors: Hongxi LIU, Kunming City (CN); Yaxia LIU, Kunming City (CN); Yuchong LIU, Kunming City (CN); Chen YANG, Kunming City (CN); Xuanhong HAO, Kunming City (CN); Yueyi WANG, Kunming City (CN)

(73) Assignee: Kunming University of Science and Technology, Kunming City (CN)

(21) Appl. No.: 19/428,736

(22) Filed: Dec. 22, 2025

(30) Foreign Application Priority Data
Dec. 25, 2024 (CN) 202411924447.8

(51) Int. Cl. C23C 24/10; B33Y 10/00; B33Y 70/00; B33Y 80/00; C22C 1/10; C22C 14/00; C22C 30/00

(52) U.S. Cl. CPC C23C 24/103; C22C 1/1078; C22C 14/00; B33Y 10/00; B33Y 70/00; B33Y 80/00; C22C 30/00

(57) ABSTRACT

Disclosed is a method for preparing an in-situ synthesized Al₂O₃ ceramic-reinforced high-entropy alloy (HEA) coating doped with a trace amount of boron (B) through laser cladding. The method includes: subjecting an Al powder, a Cr powder, a Fe powder, a Ti powder, a V powder, and a B powder to mixing thoroughly in a molar ratio of 1:1:1:1:1:0-0.1 (not zero) to obtain a laser cladding powder; and preplacing the laser cladding powder on a surface of a titanium alloy substrate, and conducting laser cladding to obtain the in-situ synthesized Al₂O₃ ceramic-reinforced HEA coating doped with the trace amount of B.

### CROSS REFERENCE TO RELATED APPLICATION

This patent application claims the benefit and priority of Chinese Patent Application No. 202411924447.8 filed with the China National Intellectual Property Administration on Dec. 25, 2024, the disclosure of which is incorporated by reference herein in its entirety as part of the present application.

### TECHNICAL FIELD

The present disclosure relates to the technical field of laser surface modification for titanium alloys, and particularly relates to a method for preparing an in-situ synthesized Al₂O₃ ceramic-reinforced high-entropy alloy (HEA) coating doped with a trace amount of B through laser cladding.

### BACKGROUND

In the field of materials science and engineering, titanium and alloys thereof are widely used in aerospace, chemical industry, medicine, etc. due to excellent mechanical properties, prominent corrosion resistance, and exceptional biocompatibility. However, the application of pure titanium and conventional titanium alloys is limited in some extreme environments, such as high-temperature oxidizing conditions or scenarios with severe wear. Thus, the development of surface modification technologies with improved performance, such as surface coating manufacturing, has become the key to expanding the application range of titanium-based materials.

HEAs are a class of novel materials that have rapidly developed in recent years. Since the introduction of HEAs by Yeh et al. in 2004, HEAs have garnered extensive attention due to exceptional properties such as low-temperature toughness, thermal stability, wear resistance, and corrosion resistance. HEAs are preferred materials for producing coatings on surfaces of titanium-based materials.

Currently, the primary techniques for manufacturing HEA coatings include magnetron sputtering, electrochemical deposition, thermal spraying, etc. The magnetron sputtering technique has advantages primarily including high film-forming rate, excellent film adhesion, and ability to achieve large-area coating. The electrochemical deposition technique involves a simple process and allows the adjustment of a composition by changing electrodeposition parameters. The thermal spraying technique could obtain coatings with thicknesses ranging from tens to hundreds of micrometers. However, coatings produced by these techniques commonly undergo defects such as pores, microcracks, and inclusions, have low bonding strengths, and tend to fall off, which affects the wear resistance and high-temperature oxidation resistance of these coatings.

In recent years, to further enhance the hardness, wear resistance, and high-temperature oxidation resistance of HEAs, researchers have begun to draw inspiration from the traditional metals and the research approach of ceramic-reinforced composites. As a result, high-hardness, wear-resistant, and high-temperature-resistant ceramic phases are introduced into HEAs to further improve the overall performance. Currently, common ceramic reinforcement phases mainly include Al₂O₃, TiC, TiB, WC, NbC, ZrC, etc., which are distributed in coatings through either direct addition or in-situ synthesis. In-situ synthesized ceramic phases demonstrate numerous advantages, which endow coatings with superior performance and stability in use. In-situ synthesized ceramic phases could be introduced through magnetron sputtering, electrochemical deposition, and thermal spraying. However, due to differences in thermophysical properties between ceramic phases and coating matrixes, the introduction of ceramic reinforcement phases often leads to issues such as embrittlement and cracking of coatings. These issues further exacerbate the drawbacks of coatings formed by magnetron sputtering, electrochemical deposition, and thermal spraying, including high defect density, low bonding strength, and poor adhesion, thereby severely compromising the hardness, wear resistance, and high-temperature oxidation resistance of these coatings. This phenomenon restricts the application of HEA coatings in practical projects.

### SUMMARY

An object of the present disclosure is to provide a method for preparing an in-situ synthesized Al₂O₃ ceramic-reinforced HEA coating doped with a trace amount of boron (B) through laser cladding, so as to solve the problems mentioned in the background.

To achieve the above objects, the present disclosure provides the following solutions:

A first technical solution of the present disclosure is as follows: A method for preparing an in-situ synthesized Al₂O₃ ceramic-reinforced HEA coating doped with a trace amount of B through laser cladding is provided, including the following steps:

subjecting an Al powder, a Cr powder, a Fe powder, a Ti powder, a V powder, and a B powder to mixing thoroughly in a molar ratio of 1:1:1:1:1:0-0.1 to obtain a laser cladding powder; and preplacing the laser cladding powder on a surface of a titanium alloy substrate, and conducting laser cladding to obtain the in-situ synthesized Al₂O₃ ceramic-reinforced HEA coating doped with the trace amount of B, where an amount of the B powder is not zero.

At high temperatures, Al, Ti, and Cr could form an oxide film to enhance the oxidation resistance of the HEA coating. Further, the large atomic radius of Ti induces lattice distortion, thereby enhancing the strength and hardness of the HEA coating. Moreover, the simultaneous addition of V and Cr could provide effective oxidation protection at different temperatures and enhance the wear resistance of the HEA coating. Finally, the presence of Fe could promote the formation of body-centered cubic (BCC) solid solution. In the HEA coating prepared with the Al powder, the Cr powder, the Fe powder, the Ti powder, and the V powder as main raw materials in the present disclosure, the various components play a synergistic role to enable the coating to possess high hardness, excellent wear resistance, and prominent high-temperature oxidation resistance. In addition, during the laser cladding, O in the air and Al could in-situ generate an Al₂O₃ ceramic phase. In the present disclosure, a trace amount of B (boron) is doped in HEA. The solid solubility of B in Ti is 0.05%, but the solid solubility of B in Al is only 0.001%. Since the solid solubility of B in Ti is far higher than the solid solubility of B in Al, the introduced B is more likely to occupy the interstitial sites of Ti during the laser cladding, thereby suppressing the reaction between O and Ti and further promoting the formation of Al₂O₃ ceramic reinforcement phases. The increase in Al₂O₃ ceramic reinforcement phases could improve the frictional wear resistance and high-temperature oxidation resistance of the HEA coating.

Further, the laser cladding is an eco-friendly surface modification technology, which uses a high-energy laser beam as a heat source, melts a metal raw material powder and then rapidly solidifies to form a coating. During the laser cladding, the laser has a high energy density and could rapidly melt refractory metal elements, and a molten metal could be rapidly solidified in a molten pool to obtain an alloy with fine microstructural grains and without significant component segregation. This design could reduce the defects of the coating, enhance the bonding strength between the coating and the substrate, and mitigate issues such as embrittlement and cracking caused by the introduction of ceramic reinforcement phases. In the present disclosure, the HEA material achieves metallurgical bonding with the titanium alloy substrate through the laser cladding. There is an excellent bonding strength between the substrate and the cladding layer, and the substrate undergoes minimal thermal deformation and a low dilution ratio, which further enhances the comprehensive performance of the HEA coating. In the present disclosure, the in-situ synthesized Al₂O₃ ceramic-reinforced HEA coating doped with the trace amount of B formed based on the combination of the specific HEA material composition and the specific laser cladding process possesses exceptional comprehensive properties (high hardness, high wear resistance, and excellent high-temperature oxidation resistance).

In some embodiments, the titanium alloy substrate is a TC4 titanium alloy (Ti-6Al-4V) substrate;

wherein the Ti-6Al-4V contains 5.5% to 6.75% by mass of Al and 3.5% to 4.5% by mass of V, and the balance is Ti.

The raw materials for the coating include Ti, Al, and V that are present in the Ti-6Al-4V (TC4) substrate, which could prevent the coating from being contaminated by the substrate.

In some embodiments, a molar ratio of the Al powder, the Cr powder, the Fe powder, the Ti powder, the V powder, and the B powder is in a range of 1:1:1:1:1:0.05-0.1.

If an amount of B doped is lower than the above ranges, there is a poor effect to promote the generation of an Al₂O₃ ceramic reinforcement phase. If the amount of B doped is higher than the above ranges, it may lead to increased brittleness, complicated crystal structures, and deteriorated processability.

In some embodiments, the Al powder, the Cr powder, the Fe powder, the Ti powder, the V powder, and the B powder each have a purity of not less than 99.95% and a particle size of 45 μm to 75 μm.

The selection of metal powders within this particle size range as raw materials for laser cladding to prepare the coating is conducive to the production of a uniform and dense coating.

In some embodiments, the mixing is conducted through ball-milling; and the ball-milling is conducted for 2 h to 6 h at a rotational speed of 100 rpm to 120 rpm.

In some embodiments, after the ball-milling is completed, the method further includes subjecting a resulting material to drying; and the drying is conducted at 80° C. for 10 h to 12 h.

In some embodiments, the laser cladding is conducted in a mixed atmosphere of a protective gas and air.

In some embodiments, the laser cladding is conducted under the following parameters: a laser power of 600 W to 800 W, a scanning speed of 200 mm/min to 400 mm/min, a spot diameter of 3 mm to 5 mm, a defocus amount of 210 mm to 230 mm, the protective gas of argon; and a flow rate of the protective gas of 14 L/min to 16 L/min, and a concentration of the protective gas in the mixed atmosphere of 70 vol %.

In some embodiments, before the laser cladding powder is preplaced on the surface of the titanium alloy substrate, the method further includes subjecting the titanium alloy substrate to pretreatment; and the pretreatment is conducted as follows: polishing, ultrasonically cleaning, and drying the titanium alloy substrate sequentially.

The polishing is primarily intended to remove oxide films, contaminants, and defects from the surface of the titanium alloy substrate, such that the surface is smooth. As a result, a bonding area between the coating and the substrate increases, thereby enhancing the bonding strength. The polishing could also eliminate unevenness and defects on the surface of the titanium alloy substrate, and reduce the likelihood of crack formation in the coating during the laser cladding. The ultrasonic cleaning could further remove residual impurities and oil stains after the polishing, ensuring a clean and pollution-free surface of the substrate. Thus, the poor bonding between the coating and the substrate caused by impurities could be minimized to ensure the uniformity and densification of the coating. The ultrasonic cleaning could also disrupt gas and liquid films adsorbed on the surface of the substrate to reduce the formation of bubbles during the coating preparation. In summary, the pretreatment contributes to ensuring a bonding strength between the coating and the substrate and a quality of the coating.

A second technical solution of the present disclosure is an in-situ synthesized Al₂O₃ ceramic-reinforced HEA coating doped with the trace amount of B prepared by the method as described in the above technical solutions.

In some embodiments, the in-situ synthesized Al₂O₃ ceramic-reinforced HEA coating doped with the trace amount of B has a thickness of 1.0 mm to 1.5 mm.

Some embodiments of the present disclosure exhibit the following technical effects:

The HEA coating doped with the trace amount of B produced through laser cladding in the present disclosure exhibits a favorable macroscopic morphology (with few defects) and achieves excellent metallurgical bonding with the substrate. The HEA coating also possesses high hardness, outstanding wear resistance, and excellent high-temperature oxidation resistance.

In the present disclosure, an in-situ synthesized Al₂O₃ ceramic-reinforced HEA coating doped with the trace amount of B is formed on a surface of a titanium alloy through laser cladding to address the inherent poor frictional wear resistance and high-temperature oxidation resistance of the titanium alloy. The formation of the coating actively promotes the practical engineering application of titanium alloys in extreme environments.

### BRIEF DESCRIPTION OF THE DRAWINGS

To describe the technical solutions in the embodiments of the present disclosure or in the prior art clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 shows a surface morphology of the in-situ synthesized Al₂O₃ ceramic-reinforced HEA coating prepared through laser cladding in Example 2;

FIG. 2 shows surface X-ray diffraction (XRD) patterns of in-situ synthesized Al₂O₃ ceramic-reinforced HEA coatings prepared through laser cladding in Examples 1 to 2 and Comparative Example 1;

FIG. 3A and FIG. 3B show cross-sectional scanning electron microscopy (SEM) images of the in-situ synthesized Al₂O₃ ceramic-reinforced HEA coating prepared through laser cladding in Comparative Example 1;

FIG. 4A and FIG. 4B show cross-sectional SEM images of the in-situ synthesized Al₂O₃ ceramic-reinforced HEA coating prepared through laser cladding in Example 1;

FIG. 5A and FIG. 5B shows cross-sectional SEM images of the in-situ synthesized Al₂O₃ ceramic-reinforced HEA coating prepared through laser cladding in Example 2;

FIG. 6 is a microhardness trend chart of the in-situ synthesized Al₂O₃ ceramic-reinforced HEA coatings prepared through laser cladding in Examples 1 to 2 and Comparative Example 1;

FIG. 7 is a wear rate trend chart of the in-situ synthesized Al₂O₃ ceramic-reinforced HEA coatings prepared through laser cladding in Examples 1 to 2 and Comparative Example 1 and a TC4 substrate; and

FIG. 8 shows oxidation kinetics curves of the in-situ synthesized Al₂O₃ ceramic-reinforced HEA coatings prepared through laser cladding in Examples 1 to 2 and Comparative Example 1 and the TC4 substrate oxidized at 900° C. for 50 hours.

### DETAILED DESCRIPTION OF THE EMBODIMENTS

A plurality of exemplary embodiments of the present disclosure are now described in detail. The detailed description should not be considered as a limitation to the present disclosure, but should be understood as a detailed description of some aspects, features, and embodiments of the present disclosure.

It should be understood that terms described in the present disclosure are merely used to describe specific embodiments and are not intended to limit the present disclosure. In addition, for a numerical range in the present disclosure, it should be understood that each intermediate value between an upper limit and a lower limit of the range is also specifically disclosed. Each small range between any stated value or an intermediate value in a stated range and any other stated value or an intermediate value in the stated range is also included in the present disclosure. Upper and lower limits of each of these small ranges can independently be included in or excluded from the range.

Unless otherwise stated, all technical and scientific terms used herein have the same meanings as commonly understood by those of ordinary skill in the art described in the present disclosure. Although only preferred methods and materials are described in the present disclosure, any methods and materials similar or equivalent to those described herein can also be used in the implementation or testing of the present disclosure. All documents mentioned in this specification are incorporated by reference to disclose and describe methods and/or materials related to the documents. In case of conflict with any incorporated documents, the content of this specification shall prevail.

It is obvious to a person skilled in the art that a plurality of modifications and variations can be made to the specific embodiments of the specification of the present disclosure without departing from the scope or spirit of the present disclosure. Other embodiments derived from the specification of the present disclosure are obvious to a person skilled in the art. The specification and embodiments of the present disclosure are merely exemplary.

As used herein, the terms such as “including”, “comprising”, “having”, “containing”, etc. are all open-ended, which means including but not limited to.

The present disclosure provides a method for preparing an in-situ synthesized Al₂O₃ ceramic-reinforced HEA coating doped with a trace amount of B through laser cladding, including the following steps:
subjecting an Al powder, a Cr powder, a Fe powder, a Ti powder, a V powder, and a B powder to mixing in a molar ratio of 1:1:1:1:1:0-0.1 and then ball-milling to obtain a laser cladding powder, and spreading the laser cladding powder in a strip pattern on a surface of a titanium alloy substrate to form a strip-shaped preplaced layer; and then subjecting the strip-shaped preplaced layer to laser cladding (that is, the titanium alloy substrate and the preplaced layer are simultaneously melted by a laser cladding system, and an HEA coating is formed on a surface of the titanium alloy under an action of a high-energy laser beam) to obtain the in-situ synthesized Al₂O₃ ceramic-reinforced HEA coating doped with the trace amount of B.

In some embodiments of the present disclosure, the titanium alloy substrate is a TC4 titanium alloy substrate.

In some embodiments of the present disclosure, a molar ratio of the Al powder, the Cr powder, the Fe powder, the Ti powder, the V powder, and the B powder is in a range of 1:1:1:
1:1:0.05-0.1.

In some embodiments of the present disclosure, the Al powder, the Cr powder, the Fe powder, the Ti powder, the V powder, and the B powder each have a purity of not less than 99.95% and a particle size of 45 μm to 75 μm.

In some embodiments of the present disclosure, the ball-milling is conducted for 2 h to 6 h at a rotational speed of 100 rpm to 120 rpm.

In some embodiments of the present disclosure, the ball-milling is conducted with a ratio of ball to material being 4:1.

In some embodiments of the present disclosure, after the ball-milling is completed, the method further includes subjecting a resulting material to drying. The drying is conducted at 80° C. for 10 h to 12 h. The drying is specifically vacuum drying.

In some embodiments of the present disclosure, the laser cladding is conducted in a mixed atmosphere of a protective gas and air.

In some embodiments of the present disclosure, the laser cladding is conducted under the following parameters: a laser power of 600 W to 800 W, a scanning speed of 200 mm/min to 400 mm/min, a spot diameter of 3 mm to 5 mm, a defocus amount of 210 mm to 230 mm, and the protective gas of argon, a flow rate of the protective gas of 14 L/min to 16 L/min, and a concentration of the protective gas in the mixed atmosphere of 70 vol %.

In some embodiments of the present disclosure, before the laser cladding powder is preplaced on the surface of the titanium alloy substrate, the method further includes subjecting the titanium alloy substrate to a pretreatment. The pretreatment is specifically as follows: polishing, ultrasonically cleaning, and drying the titanium alloy substrate sequentially.

In some embodiments of the present disclosure, the polishing is specifically conducted with a 200-grit sandpaper and a 350-grit sandpaper sequentially, the ultrasonic cleaning is specifically conducted in absolute ethanol, and the drying is conducted at a temperature of 60° C. to 80° C. for 2 h to 3 h.

The present disclosure also provides the in-situ synthesized Al₂O₃ ceramic-reinforced HEA coating doped with the trace amount of B prepared by the method as described above.

In some embodiments of the present disclosure, the in-situ synthesized Al₂O₃ ceramic-reinforced HEA coating doped with the trace amount of B has a thickness of 1.0 mm to 1.5 mm.

The technical solutions of the present disclosure are further described below in conjunction with specific examples.

The room temperature mentioned in the specific examples of the present disclosure specifically refers to a temperature of 20° C. to 30° C.

The Al powder, the Cr powder, the Fe powder, the Ti powder, the V powder, and the B powder used in the following examples and comparative example each have a purity of not less than 99.95% and a particle size of 45 μm to 75 μm.

The TC4 titanium alloy substrate used in the following examples and comparative example has a dimension of 40 mm×14 mm×4 mm.

### Example 1

A method for preparing an in-situ synthesized Al₂O₃ ceramic-reinforced HEA coating doped with a trace amount of B through laser cladding was conducted by the following steps:
(1) Al, Cr, Fe, Ti, V, and B metal powders were weighed in a molar ratio of 1:1:1:1:1:0.05. A resulting mixture was subjected to high-energy ball-milling in a ball mill using grinding balls with a diameter of 5 mm (materials of the ball mill and grinding balls were stainless steel). The high-energy ball-milling was conducted for 4 h at a rotational speed of 100 rpm with a ratio of a ball to a material being 4:1. A resulting system obtained after the ball-milling was subjected to standing for 3 h until the resulting system reached room temperature to obtain a mixed metal powder.
(2) The mixed metal powder obtained after the high-energy ball-milling was placed in a drying oven and dried at 80° C. for 10 h to obtain a laser cladding powder.
(3) A TC4 titanium alloy substrate was pretreated specifically as follows: The TC4 titanium alloy substrate was polished with a 200-grit metallographic sandpaper and a 350-grit metallographic sandpaper sequentially until a surface of the TC4 titanium alloy substrate was smooth to remove oxide films, contaminants, and defects on the surface, thereby reducing the reflection of the surface of the TC4 titanium alloy substrate for a laser. A polished TC4 titanium alloy substrate was rinsed with clean water and then ultrasonically cleaned in absolute ethanol for 5 min to remove residual oil stains and impurities on a surface of the polished TC 4 titanium alloy substrate, and then dried in a drying oven at 80° C. for 2 h to obtain a pretreated TC4 titanium alloy substrate.
(4) The laser cladding powder was preplaced on a surface of the pretreated TC4 titanium alloy substrate. Specifically, the laser cladding powder was spread in a strip pattern on the surface of the pretreated TC4 titanium alloy substrate to form a strip-shaped preplaced layer.
(5) Laser cladding was conducted to obtain the in-situ synthesized Al₂O₃ ceramic-reinforced HEA coating doped with the trace amount of B (an amount of the laser cladding powder was controlled to finally obtain a coating with a thickness of 1.5 mm). The laser cladding was conducted in a mixed atmosphere of a protective gas and air under the following parameters: a laser power of 700 W, a scanning speed of 300 mm/min, a spot diameter of 3 mm, and a defocus amount of 220 mm, the protective gas of argon, and a flow rate of argon of 15 L/min, a concentration of argon in the mixed atmosphere being maintained at 70 vol % by controlling a flow rate of the air.

### Example 2

This example was the same as Example 1, except that the Al, Cr, Fe, Ti, V, and B metal powders were weighed in a molar ratio of 1:1:1:1:1:0.1 as raw materials.

Comparative Example 1

This example was the same as Example 1, except that the Al, Cr, Fe, Ti, and V metal powders were weighed in a molar ratio of 1:1:1:1:1 as raw materials, that is, the doping of the trace amount of B was omitted.

### Test Example

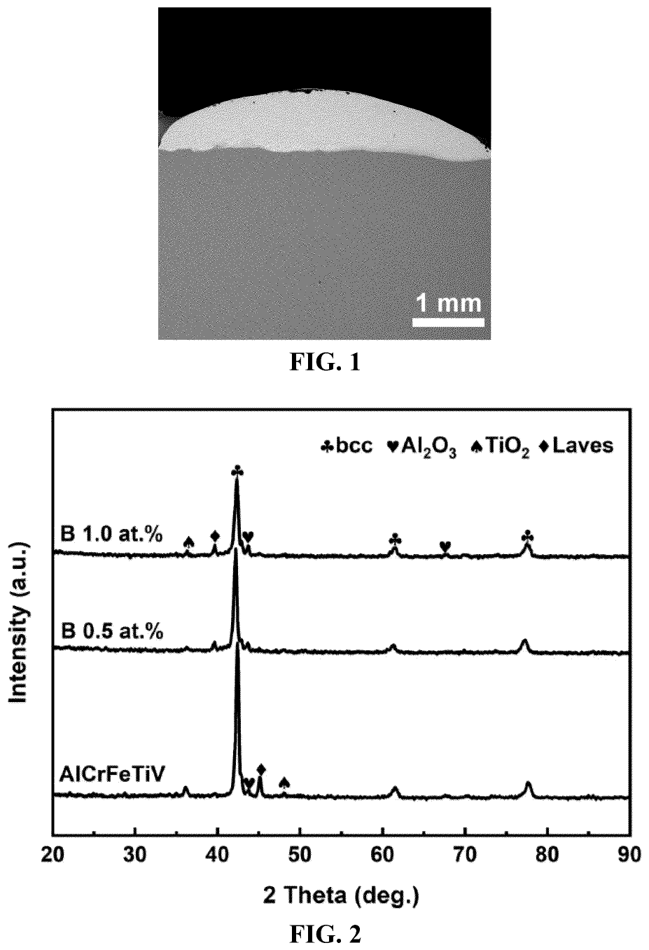

The in-situ synthesized Al₂O₃ ceramic-reinforced HEA coating prepared through laser cladding in Example 2 was subjected to morphology analysis. FIG. 1 shows a surface morphology of the in-situ synthesized Al₂O₃ ceramic-reinforced HEA coating prepared through laser cladding in Example 2. As shown in FIG. 1, the HEA material achieves metallurgical bonding with the titanium alloy substrate through the laser cladding. There is an excellent bonding strength between the substrate and the cladding layer, and the substrate undergoes minimal thermal deformation and a low dilution ratio.

The in-situ synthesized Al₂O₃ ceramic-reinforced HEA coatings prepared through laser cladding in Examples 1 to 2 and Comparative Example 1 were each subjected to phase analysis. FIG. 2 shows XRD patterns of the coatings prepared in Examples 1 to 2 and Comparative Example 1. As shown in FIG. 2, structures of the three coatings each include a BCC phase, a TiO₂ phase, an Al₂O₃ phase, and a Laves phase (intermetallic compound). After the trace amount of B is added, TiO₂ phases in a coating gradually decrease, Al₂O₃ phases increase, and Laves phases also diminish. These changes are associated with adjustments in the crystal structure and chemical composition induced by the introduction of B.

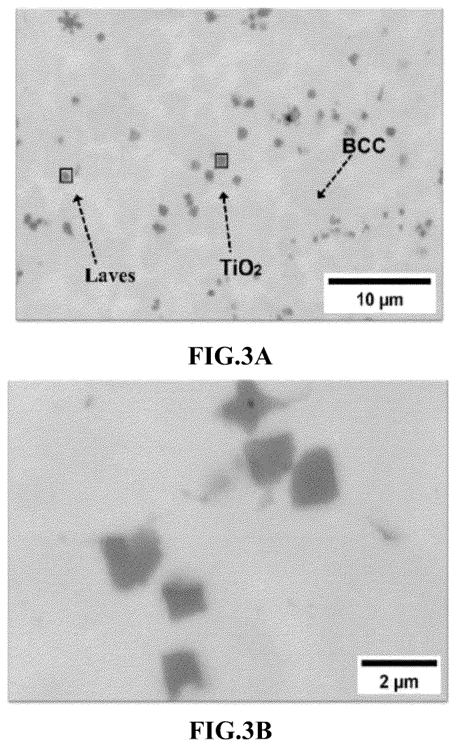

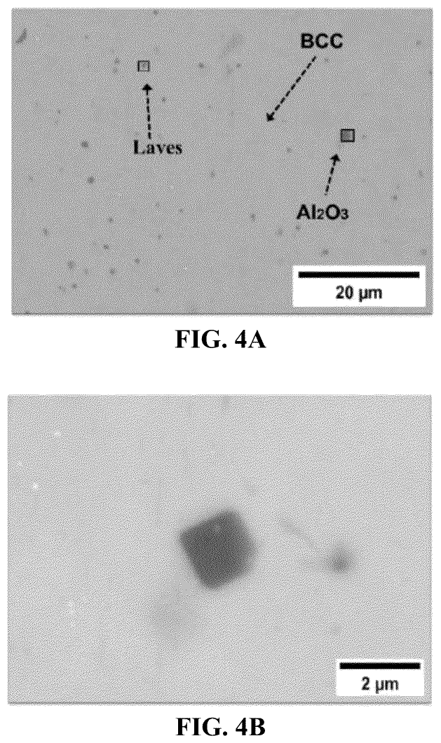

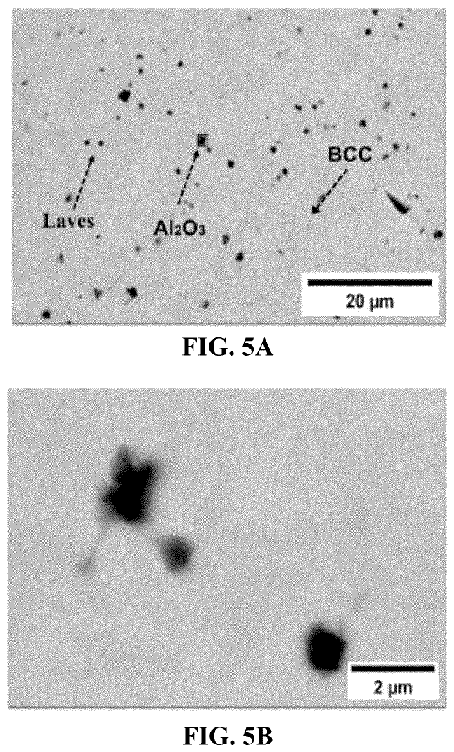

The in-situ synthesized Al₂O₃ ceramic-reinforced HEA coatings prepared through laser cladding in Examples 1 to 2 and Comparative Example 1 each were subjected to cross-sectional microscopy analysis. Before the cross-sectional microscopy analysis, cross-sections of samples each were polished with a 180-grit sandpaper, a 400-grit sandpaper, an 800-grit sandpaper, and a 1,200-grit sandpaper sequentially until surfaces of the samples were smooth and free of significant scratches. Polished samples each were cleaned with absolute ethanol and clean water, and then blow-dried with a blow dryer to obtain samples suitable for microscopy analysis. Cross-sectional morphologies of the coatings in Examples 1 to 2 and Comparative Example 1 are shown in FIG. 3A to FIG. 5B (FIG. 3 A and FIG. 3B are for Comparative Example 1, FIG. 4A and FIG. 4B are for Example 1, and FIG. 5A and FIG. 5B are for Example 2). It can be clearly seen that each of the coatings mainly includes a BCC phase and oxide phases that have different structures, and also includes a small amount of a Laves phase. The BCC phase is presented as a white region in an image, while dark-gray precipitated phases correspond to TiO₂ and Al₂O₃ phases. Moreover, as a content of B increases, cracks and pores in a coating gradually decrease.

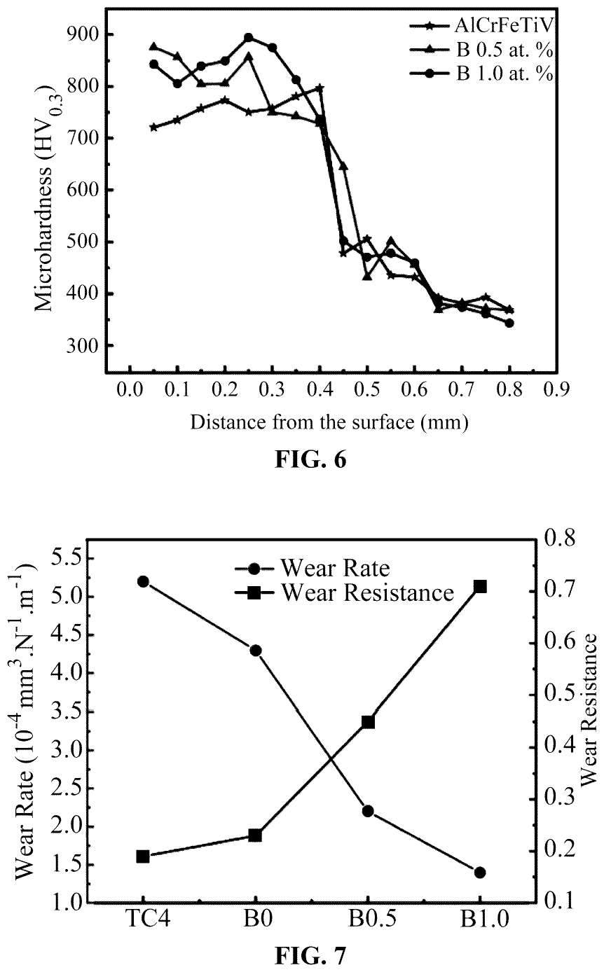

Hardnesses of the in-situ synthesized Al₂O₃ ceramic-reinforced HEA coatings prepared through laser cladding in Examples 1 to 2 and Comparative Example 1 were measured with a microhardness tester. The measured hardness trends are shown in FIG. 6 (where AlCrFeTiV represents Comparative Example 1, B 0.5 at. % represents Example 1, and B 1.0 at. % represents Example 2). It can be known that, with the increase in the B content, the hardness of the coating is significantly improved, which is attributed to the following two major factors: 1. B atoms occupy interstitial sites of BCC, and are dissolved in BCC to form an interstitial solid solution, thereby contributing to solid-solution strengthening. 2. As the B content in the coating increases, the content of the Al₂O₃ ceramic phase in the coating also increases. As a high-hardness ceramic phase, Al₂O₃ plays a second-phase pinning reinforcement role in the coating to effectively enhance the hardness of the coating.

The in-situ synthesized Al₂O₃ ceramic-reinforced HEA coatings prepared through laser cladding in Examples 1 to 2 and Comparative Example 1 and the TC4 substrate each were tested with a reciprocating friction and wear tester (UMT-2) for wear resistance. The measured wear rate trends are shown in FIG. 7 (where TC4 represents the substrate, B0 represents Comparative Example 1, B 0.5 represents Example 1, and B 1.0 represents Example 2). It can be seen that wear resistance levels of the B 0, B 0.5, and B 1.0 coatings are 1.21 times, 2.36 times, and 3.71 times higher than a wear resistance level of the TC4 substrate, respectively. The HEA coating with 1.0 at. % of B has the lowest wear rate. This is because the increase in the B content in the coating makes the content of the Al₂O₃ ceramic phase increase, resulting in improved wear resistance of the coating. These experimental results show that the addition of B at varying contents to the AlCrFeTiV HEA system could effectively improve the hardness and frictional wear resistance of the TC4 titanium alloy.

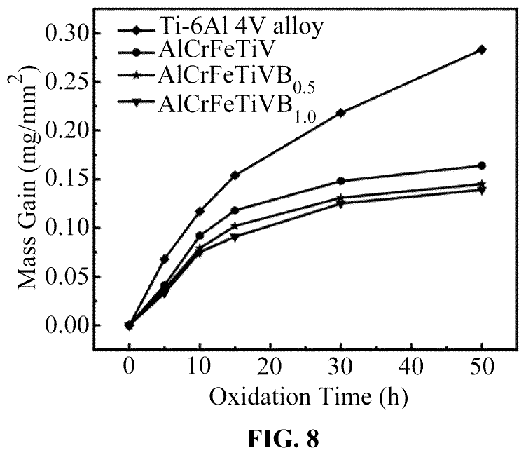

The in-situ synthesized Al₂O₃ ceramic-reinforced HEA coatings prepared through laser cladding in Examples 1 to 2 and Comparative Example 1 and the TC4 substrate each were subjected to an isothermal (900° C.) oxidation test in air for 50 h. Resulting oxidation kinetics curves are shown in FIG. 8 (where Ti-6Al-4V alloy represents the TC4 substrate, AlCrFeTiV represents Comparative Example 1, AlCrFeTiVB_{0.5} represents Example 1, and AlCrFeTiVB_{1.0} represents Example 2). The curves reveal that oxidation-induced weight gains of the three coatings are significantly lower than an oxidation-induced weight gain of the TC4 substrate, and oxidation-induced weight gains of Examples 1 and 2 with B are lower than an oxidation-induced weight gain of Comparative Example 1 without B. It indicates that the addition of an appropriate amount of B could significantly improve the high-temperature oxidation resistance of the HEA coating. This performance improvement may be attributed to the ability of B to promote the generation of Al₂O₃, which could increase the surface density of the coating, effectively inhibit the diffusion of oxygen, and slow down the oxidation of the coating.

The above embodiments are only intended to describe the preferred embodiments of the present disclosure, but not to limit the scope of the present disclosure. Various alterations and improvements made by those of ordinary skill in the art based on the technical solutions of the present disclosure without departing from the design spirit of the present disclosure shall fall within the scope of the appended claims of the present disclosure.

What is claimed is:

1. A method for preparing an in-situ synthesized Al₂O₃ ceramic-reinforced high-entropy alloy (HEA) coating doped with a trace amount of boron (B) through laser cladding, comprising the following steps:
subjecting an Al powder, a Cr powder, a Fe powder, a Ti powder, a V powder, and a B powder to mixing in a molar ratio of 1:1:1:1:1:0-0.1 to obtain a laser cladding powder; and
preplacing the laser cladding powder on a surface of a titanium alloy substrate, and conducting laser cladding to obtain the in-situ synthesized Al₂O₃ ceramic-reinforced HEA coating doped with the trace amount of B,
wherein an amount of the B powder is not zero.

2. The method for preparing the in-situ synthesized Al₂O₃ ceramic-reinforced HEA coating doped with the trace amount of B through laser cladding of claim 1, wherein the titanium alloy substrate is a TC4 titanium alloy substrate.

3. The method for preparing the in-situ synthesized Al₂O₃ ceramic-reinforced HEA coating doped with the trace amount of B through laser cladding of claim 1, wherein the Al powder, the Cr powder, the Fe powder, the Ti powder, the V powder, and the B powder each have a purity of not less than 99.95% and a particle size of 45 micrometres (μm) to 75 μm.

4. The method for preparing the in-situ synthesized Al₂O₃ ceramic-reinforced HEA coating doped with the trace amount of B through laser cladding of claim 1, wherein the mixing is conducted through ball-milling; and the ball-milling is conducted for 2 hours (h) to 6 h at a rotational speed of 100 revolutions per minute (rpm) to 120 rpm.

5. The method for preparing the in-situ synthesized Al₂O₃ ceramic-reinforced HEA coating doped with the trace amount of B through laser cladding of claim 4, wherein after the ball-milling is completed, the method further comprises subjecting a resulting material to drying; and
the drying is conducted at 80° C. for 10 h to 12 h.

6. The method for preparing the in-situ synthesized Al₂O₃ ceramic-reinforced HEA coating doped with the trace amount of B through laser cladding of claim 1, wherein the laser cladding is conducted in a mixed atmosphere of a protective gas and air.

7. The method for preparing the in-situ synthesized Al₂O₃ ceramic-reinforced HEA coating doped with the trace amount of B through laser cladding of claim 6, wherein the laser cladding is conducted under the following parameters: a laser power of 600 watts (W) to 800 W, a scanning speed of 200 millimeters/minute (mm/min) to 400 mm/min, a spot diameter of 3 mm to 5 mm, a defocus amount of 210 mm to 230 mm, the protective gas being argon; and a flow rate of the protective gas of 14 L/min to 16 L/min, and a concentration of the protective gas in the mixed atmosphere of 70 vol %.

8. The method for preparing the in-situ synthesized Al₂O₃ ceramic-reinforced HEA coating doped with the trace amount of B through laser cladding of claim 1, wherein before preplacing the laser cladding powder on the surface of the titanium alloy substrate, the method further comprises subjecting the titanium alloy substrate to pretreatment; and the pretreatment is conducted as follows: polishing, ultrasonically cleaning, and drying the titanium alloy substrate sequentially.

9. An in-situ synthesized Al₂O₃ ceramic-reinforced HEA coating doped with a trace amount of B prepared by the method of claim 1.

10. The in-situ synthesized Al₂O₃ ceramic-reinforced HEA coating doped with the trace amount of B of claim 9, wherein the in-situ synthesized Al₂O₃ ceramic-reinforced HEA coating doped with the trace amount of B has a thickness of 1.0 mm to 1.5 mm.
